(19) United States
(12) Patent Application Publication
(10) Pub. No.: US 2026/0228218 A1
(43) Pub. Date: Aug. 6, 2026

(54) GRAPH QUERY METHOD

(71) Applicant: ALIBABA INNOVATION PRIVATE LIMITED, Singapore (SG)

(72) Inventors: Longbin LAI, Hangzhou, Zhejiang (CN); Yufan YANG, Hangzhou, Zhejiang (CN); Haotian MA, Hangzhou, Zhejiang (CN); Yuxuan LIU, Hangzhou, Zhejiang (CN); Bingqing LYU, Shanghai (CN); Xiaoli ZHOU, Shanghai (CN); Sijie SHEN, Shanghai (CN); Wenyuan YU, Beijing (CN); Jingren ZHOU, Bellevue, WA (US); Yeqing ZHONG, Hangzhou, Zhejiang (CN)

(21) Appl. No.: 19/157,484

(22) PCT Filed: Apr. 1, 2024
(86) PCT No.: PCT/SG2024/050212

§ 371 Date: Aug. 18, 2025

(30) Foreign Application Priority Data
Apr. 12, 2023 (CN) 202310413647.6

(51) Int. Cl. G06F 16/2453; G06F 16/901

(52) U.S. Cl. CPC G06F 16/24542; G06F 16/9024

(57) ABSTRACT

Embodiments of the present disclosure provide a graph query method. The method is applied to a client, and includes that: a sub-graph query statement sent by a user for an initial property graph is parsed, and a sub-graph structure corresponding to the sub-graph query statement is generated; a target sub-graph query execution policy in a preset calculation manner is determined based on sub-graph statistical information and the sub-graph structure, where the sub-graph statistical information is obtained from a graph data structure constructed based on a target property graph; the target sub-graph query execution policy is encoded into a data flow structure, and the data flow structure is sent to a service end; and a target sub-graph returned by the service end is received after the service end performs querying in the initial property graph based on the data flow structure, and the target sub-graph is returned to the user.

### CROSS-REFERENCE TO RELATED APPLICATIONS

The present disclosure claims priority of Chinese Patent Application No. 202310413647.6, filed to China National Intellectual Property Administration on Apr. 12, 2023 and titled “GRAPH QUERY METHOD”, the content of which is hereby incorporated by reference in its entirety.

### TECHNICAL FIELD

Embodiments of the present disclosure relate to the field of computer technologies, and in particular, to a graph query method.

### BACKGROUND OF THE INVENTION

In recent years, with continuous development of a platform-type Internet, a large amount of data is accumulated on each website. Increase of the data, on one hand, brings more valuable information, and on the other hand, greatly increases difficulty in extracting the information from the data. Therefore, how to efficiently extract the valuable information from the large amount of data that continuously increases becomes a troublesome problem.

An association between data is extremely valuable information, and is widely applied to a recommendation system of a website such as social networking and shopping. Currently, a relational database is usually used in each website to store various types of data and associations between the data. However, the relational database is not inherently designed for the association. As a result, an additional table needs to be introduced to maintain the association between the data, and a foreign key is required for constraint. This design leads to a result that the database needs to connect multiple tables when matching between objects needs to be performed across multiple associations, and consequently, computation costs of the database become very high. When a data amount increases to a particular scale, a computation result cannot be generated within reasonable duration based on the design of the relational database. As a result, the relational database cannot be used in a scenario in which high real-time performance is required.

Therefore, an efficient graph query method for analyzing the association between the data urgently needs to be provided.

### SUMMARY OF THE INVENTION

In view of this, embodiments of the present disclosure provide three graph query methods. At least one embodiment of the present disclosure simultaneously relates to two graph query apparatuses, a graph query system, a computing device, a computer-readable storage medium, and a computer program, to solve technical defects in the related art.

According to a first aspect of the embodiments of the present disclosure, a graph query method is provided, applied to a client, and includes the following step.

A sub-graph query statement sent by a user for an initial property graph is parsed, and a sub-graph structure corresponding to the sub-graph query statement is generated.

A target sub-graph query execution policy in a preset calculation manner is determined based on sub-graph statistical information and the sub-graph structure, where the sub-graph statistical information is obtained from a graph data structure constructed based on a target property graph.

The target sub-graph query execution policy is encoded into a data flow structure, and the data flow structure is sent to a service end.

A target sub-graph returned by the service end is received after the service end performs querying in the initial property graph based on the data flow structure, and the target sub-graph is returned to the user.

According to a second aspect of the embodiments of the present disclosure, a graph query apparatus is provided, applied to a client, and includes:
a graph pattern parsing node, configured to parse a sub-graph query statement sent by a user for an initial property graph, and generate a sub-graph structure corresponding to the sub-graph query statement; and
a policy optimization node, configured to determine a target sub-graph query execution policy in a preset calculation manner based on sub-graph statistical information and the sub-graph structure, where the sub-graph statistical information is obtained from a graph data structure constructed based on a target property graph.

The policy optimization node is further configured to encode the target sub-graph query execution policy into a data flow structure, and send the data flow structure to a service end.

The graph pattern parsing node is further configured to receive a target sub-graph returned by the service end after the service end performs querying in the initial property graph based on the data flow structure, and return the target sub-graph to the user.

According to a third aspect of the embodiments of the present disclosure, a graph query method is provided, applied to a service end, and includes the following step.

A data flow structure sent by a client is received, and the data flow structure is sent to a target execution node of a distributed computing cluster, where the data flow structure is obtained through processing, by the client, a received sub-graph query statement.

The target sub-graph determined through performing, by the target execution node, querying in the initial property graph is obtained based on the decoding result obtained through decoding, by the target execution node, the data flow structure, and the target sub-graph is returned to the client.

According to a fourth aspect of the embodiments of the present disclosure, a graph query apparatus is provided, applied to a service end, and includes:
a distributed flow engine processing node, configured to receive a data flow structure sent by a client, and send the data flow structure to a target execution node of a distributed computing cluster, where the data flow structure is obtained through processing, by the client, a received sub-graph query statement.

The distributed flow engine processing node is further configured to obtain the target sub-graph determined through performing, by the target execution node, querying in the initial property graph based on the decoding result obtained through decoding, by the target execution node, the data flow structure, and return the target sub-graph to the client.

According to a fifth aspect of the embodiments of the present disclosure, a graph query method is provided, applied to a graph query system. The graph query system includes a client and a service end. The method includes:

The client parses a sub-graph query statement sent by a user for an initial property graph, and generates a sub-graph structure corresponding to the sub-graph query statement; determines a target sub-graph query execution policy in a preset calculation manner based on sub-graph statistical information and the sub-graph structure, where the sub-graph statistical information is obtained from a graph data structure constructed based on a target property graph; and encodes the target sub-graph query execution policy into a data flow structure, and sends the data flow structure to the service end.

The service end receives the data flow structure sent by the client, and sends the data flow structure to a target execution node of a distributed computing cluster; and obtains a target sub-graph determined through performing, by the target execution node, querying in the initial property graph based on a decoding result obtained through decoding, by the target execution node, the data flow structure, and returns the target sub-graph to the client.

The client receives the target sub-graph returned by the service end, and returns the target sub-graph to the user.

According to a sixth aspect of the embodiments of the present disclosure, a graph query system is provided. The graph query system includes a client and a service end.

The client is configured to parse a sub-graph query statement sent by a user for an initial property graph, and generate a sub-graph structure corresponding to the sub-graph query statement; determine a target sub-graph query execution policy in a preset calculation manner based on sub-graph statistical information and the sub-graph structure, where the sub-graph statistical information is obtained from a graph data structure constructed based on a target property graph; and encode the target sub-graph query execution policy into a data flow structure, and send the data flow structure to a service end.

The service end is configured to receive the data flow structure sent by the client, and send the data flow structure to a target execution node of a distributed computing cluster; and obtain a target sub-graph determined through performing, by the target execution node, querying in the initial property graph based on a decoding result obtained through decoding, by the target execution node, the data flow structure, and return the target sub-graph to the client.

The client is further configured to receive the target sub-graph returned by the service end, and return the target sub-graph to the user.

According to a seventh aspect of the embodiments of the present disclosure, a computing device is provided, including:
a memory and a processor.

The memory is configured to store computer-executable instructions. The processor is configured to execute the computer-executable instructions. When the computer-executable instructions are executed by the processor, steps of the foregoing graph query method are implemented.

According to an eighth aspect of the embodiments of the present disclosure, a computer-readable storage medium is provided, storing computer-executable instructions. When the computer-executable instructions are executed by a processor, steps of the foregoing graph query method are implemented.

According to a ninth aspect of the embodiments of the present disclosure, a computer program is provided. When the computer program is executed in a computer, the computer is enabled to perform steps of the foregoing graph query method.

The embodiments of the present disclosure implements a graph query method. The graph query method is applied to a client, and includes that: a sub-graph query statement sent by a user for an initial property graph is parsed, and a sub-graph structure corresponding to the sub-graph query statement is generated; a target sub-graph query execution policy in a preset calculation manner is determined based on sub-graph statistical information and the sub-graph structure, where the sub-graph statistical information is obtained from a graph data structure constructed based on a target property graph; the target sub-graph query execution policy is encoded into a data flow structure, and the data flow structure is sent to a service end; and a target sub-graph returned by the service end is received after the service end performs querying in the initial property graph based on the data flow structure, and the target sub-graph is returned to the user. Specifically, the graph query method provides an approach for matching and querying for a graph pattern based on the sub-graph statistical information. In full consideration of an association between the sub-graph statistical information stored in the graph data structure and information, the target sub-graph query execution policy that is better in time and space complexity is generated in combination with the preset calculation manner, and the target sub-graph query execution policy is encoded into the data flow structure that can be executed by the service end, so that subsequently the service end can efficiently analyze an association between data based on the data flow structure, and simply and quickly match and query for the graph pattern.

### BRIEF DESCRIPTION OF DRAWINGS

FIG. 1 is a schematic diagram of a specific scenario of a graph query method according to some embodiments of the present disclosure.

FIG. 2 is a flowchart of a graph query method applied to a client according to some embodiments of the present disclosure.

FIG. 3 is a schematic diagram of a graph data structure in a graph query method according to some embodiments of the present disclosure.

FIG. 4 is a flowchart of a specific processing process of a graph query method according to some embodiments of the present disclosure.

FIG. 5 is a flowchart of a graph query method applied to a service end according to some embodiments of the present disclosure.

FIG. 6 is a flowchart of a graph query method applied to a graph query system according to some embodiments of the present disclosure.

FIG. 7 is a structural schematic diagram of a graph query apparatus applied to a client according to some embodiments of the present disclosure.

FIG. 8 is a structural schematic diagram of a graph query apparatus applied to a service end according to some embodiments of the present disclosure.

FIG. 9 is a structural schematic diagram of a graph query system according to some embodiments of the present disclosure.

FIG. 10 is a structural block diagram of a computing device according to some embodiments of the present disclosure.

### DETAILED DESCRIPTION OF THE INVENTION

In the following descriptions, many specific details are described to fully understand the present disclosure. However, the present disclosure can be implemented in many other manners different from those described herein, and a person having ordinary skill in the art can make similar promotion without violating connotations of the present disclosure. Therefore, the present disclosure is not limited to specific implementations disclosed below.

The terms used in at least one embodiment of the present disclosure are used for describing specific embodiments, and are not intended to limit the at least one embodiment of the present disclosure. The terms “a” and “the” in a singular form used in at least one embodiment of the present disclosure and the appended claims are also intended to include a plural form, unless other meanings are clearly indicated in the context. It should be further understood that the term “and/or” used in at least one embodiment of the present disclosure indicates and includes any or all possible combinations of at least one associated listed items.

It should be understood that, although the terms “first”, “second”, and the like is used for describing various information in at least one embodiment of the present disclosure, such information should not be limited to these terms. These terms are used for distinguishing between information of the same type. For example, without departing from the scope of the at least one embodiment of the present disclosure, “first” may also be referred to as “second”, and similarly, “second” may also be referred to as “first”. Depending on the context, for example, the word “if” used herein is interpreted as “while” or “when,” or “in response to determining”.

In addition, it needs to be noted that user information (including, but not limited to, user equipment information, user personal information, and the like) and data (including, but not limited to, data for analysis, stored data, displayed data, and the like) involved in the embodiments of the present disclosure are all information and data authorized by a user or fully authorized by all parties, collection, use, and processing of relevant data need to comply with relevant laws, regulations, and standards of relevant countries and regions, and a corresponding operation entry is provided for the user to select to authorize or reject.

First, nouns and terms involved in at least one embodiment of the present disclosure are explained.

Graph: an abstract data structure including points and edges.

Property graph: various labels (such as products and users) and properties (such as names and jobs) are added to points and edges in the graph, to represent types or attributes to which the labels and properties belong.

Graph pattern: a special property graph with a label, and also be commonly understood as a sub-graph of a property graph.

Homomorphism mapping: a group of mapping from a graph pattern Q to a property graph G, where two sides of a pair of mapping are either points or edges, and have the same label. Particularly, for mapping of a pair of edges, both a start point and an end point at two ends of the mapping need to have corresponding mapping.

Graph pattern match: when a property graph G and a graph pattern Q are provided, all homomorphism mapping from a vertex set of the graph pattern Q to a vertex set of the property graph G is found in the property graph G.

Graph pattern matching query system: a system specifically used to match and query for a graph pattern.

Interactively: making a timely feedback to a query submitted by a user.

GLogue: a data structure based on a graph, and is used to store high-dimensional statistical information in an original data graph. In a conventional database system, the high-dimensional statistical information is also stored based on a Catalogue data structure that is based on a table. An innovation point of the GLogue lies in that the information is stored by using a graph, so that not only a specific value is stored, but also an association between the information is stored. Therefore, efficiency of the GLogue in a construction and use process is greatly improved.

GLogS: a large-scale graph pattern matching system based on the GLogue.

GLogue Manager: a GLogue management module, which is a module that is in the GLogS and that is responsible for creating, managing, and maintaining the graph data structure of the GLogue.

Graph Sparsifier: a graph sparse module, which is a module that is in the GLogS and that is responsible for sampling an original data graph, where a function thereof is to generate a small sparse graph on the premise of retaining structure information of the original data graph as much as possible. Subsequently, the GLogue Manager first performs, in the small graph, initial statistics on required information in the GLogue, and then performs scaling based on a statistical attribute, to generate an estimation of high-dimensional statistical information in the original data graph. This design can greatly increase a construction speed of the GLogue.

NP-Complete: a NP-complete problem, which is one of levels of deterministic problems in a complexity calculation theory. The NP-complete problem is an intersection of NPs and NP-hardness problems, and is a most difficult deterministic problem in NPs. All NP problems is reduced to NP-complete problems in polynomial time. When a solution for any NP-complete problem in the polynomial time is obtained, the solution is applied to all the NP problems, and may also be used to prove that the NP problem is equal to a P problem. It is commonly understood as that the NP-complete problem is a problem that has very high computing complexity and needs to consume a large quantity of computing resources.

Worst-Case-Optimal Join: Optimal Join in a worst case. In graph query and database query, the Worst-Case-Optimal Join is a general name of a type of Join algorithms. In comparison with a conventional Binary Join algorithm, this type of Join algorithms can ensure an upper limit of a quantity of intermediate results in a computing process, that is, is optimized in the worst case. Therefore, performance better than that of the Binary Join is usually provided.

Pattern Parser: in the GLogS, a Pattern inputted by a user is usually described by using a language such as Gremlin or Cypher. To further analyze these Pattern structures, the Pattern described by using the language such as Gremlin or Cypher needs to be converted into a data structure PatternDesc built in the GLogS. The Pattern Parser is responsible for this process.

Plan Optimizer: an execution policy optimizer, after obtaining the PatternDesc by using the Pattern Parser, the Plan Optimizer performs structural analysis and disassembling on the PatternDesc by using the high-dimensional statistical information stored in the GLogue, then generates a preferred execution plan (policy), and finally converts the generated execution plan into a form of DataflowDesc (a data flow structure), to send the DataflowDesc to each Dataflow Executor (data flow executor) for execution.

Gremlin Match: a match statement in a Gremlin language, used to provide semantics of Pattern Match.

PatternDesc: a pattern description structure, which is a data structure generated after the Pattern inputted by the user is converted by using the Pattern Parser. The PatternDesc describes the Pattern from a more structured visual angle, so that the Plan Optimizer performs optimization.

Cypher: The Cypher is a graph query language, and the user can extract required information from a graph by using the Cypher.

GraphQL: a query language and runtime of a service end that are oriented to an API (Application Programming Interface, application programming interface), and can be used for graph query.

DataflowDesc: a dataflow description structure, which is a data structure including a series of Dataflow operators, is used to describe a specific execution policy of a Pattern Match request in the GLogS, is generated by the Plan Optimizer, and is then sent to each Dataflow Executor for specific execution.

Map: a common operator in a Dataflow operation, and a function thereof is to convert each element in a Dataflow into a corresponding element. Assuming that elements in an original Dataflow are {x1, x2, x3, . . . , xn}, after the operator map, the Dataflow becomes {map (x1), map (x2), map (x3), . . . , map (xn)}, and map (xi) is an exact element.

FlatMap: a common operator in a Dataflow operation, and a function thereof is to convert each element in a Dataflow into zero, one, or more corresponding elements. Assuming that elements in an original Dataflow are {x1, x2, x3, . . . , xn}, after the operator FlatMap, the Dataflow becomes {flat_map (x1), flat_map (x2), flat_map (x3), . . . , flat_map (xn)}, and flat_map (xi) is a collection, including zero, one, or more elements.

Filter: a common operator in a Dataflow operation, and a function thereof is to filter each element in a Dataflow, and retain an element that satisfies a requirement. Assuming that elements in an original Dataflow are {x1, x2, x3, . . . , xn}, after the operator filter, the Dataflow becomes {xilfilter (Xi)=true}.

Distributed Dataflow Engine: a Distributed Dataflow execution engine, which can allocate a Dataflow task to each node in a distributed cluster, to fully use computing resources in the distributed cluster to accelerate the Dataflow task.

Graph Store: converts a graph into a corresponding file format for storage in a magnetic disk.

Watermark for Memory Control: a watermark for controlling an internal memory.

Early-Stop Mechanism: a mechanism for stopping execution in advance.

A graph is considered as a set of vertexes and edges, or is considered as a set of nodes and associations related to the nodes. A structure of the graph enables the graph to be proper by nature to represent an association between objects in reality or even a virtual world. A point represents an object, and an edge represents an association between objects. Therefore, when various types of data and associations of the various types of data are stored by using the graph, and analysis is performed based on the graph, not only expression is clearer, but also a speed and efficiency of data analysis can be greatly improved. An objective of graph pattern matching is to mine a meaningful sub-graph structure from graph data, so as to analyze an association between data in a higher dimension and extract more valuable information. For example, on an e-commerce website, a platform side usually needs to know how much impact “a user follows a store” has on contribution to a final sales volume. This scenario can be easily described by using a triangle pattern among “user”, “store”, and “product” based on sub-graph pattern matching, and all sub-graphs (graph patterns) matching the pattern are found in a data graph of the e-commerce website for further analysis. However, a data storage system dominated by a relational database is difficult to be implemented.

Therefore, it can be learned that the graph pattern matching has a large application prospect. However, the graph pattern matching is an NP-Complete problem, and can be greatly optimized. However, some existing systems supporting graph pattern matching and query have large defects at least in at least one of graph description language support, execution policy optimization, distributed execution support, and large-scale graph data support, and cannot be applied to an actual scenario.

Based on this, the present disclosure provides three graph query methods. At least one embodiment of the present disclosure simultaneously relates to two graph query apparatuses, a graph query system, a computing device, a computer-readable storage medium, and a computer program, which are described one by one in detail in the following embodiments.

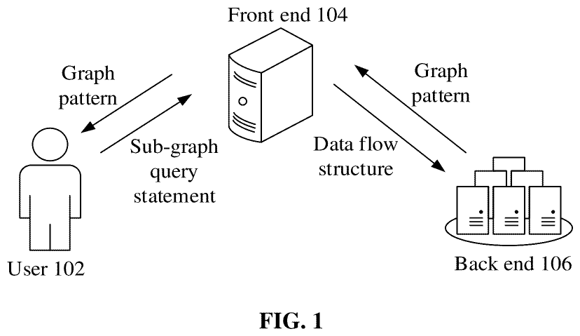

FIG. 1 is a schematic diagram of a specific scenario of a graph query method according to some embodiments of the present disclosure.

A user 102, a front end 104, and a back end 106 are shown in FIG. 1. The user 102 is understood as an operation staff, a development staff, or the like of a target item (such as a shopping website or a social networking website). The front end 104 and the back end 106 may both be understood as servers, such as physical servers or cloud servers. A difference lies in that the front end 104 and the back end 106 are responsible for different processing events. During actual application, since the front end 104 is user-oriented, the front end 104 is also referred to as a client below.

During actual application, the front end 104 and the back end 106 form a graph query system (that is, a graph pattern matching and query system, such as a GLogS). The graph query method is applied to the graph query system, and may comprehensively interconnect, in an end-to-end manner, all links in a process from inputting a query statement on a user side to finally returning a query result by an execution engine, so that a high-frequency requirement of graph pattern matching and query is highly available in an actual item scenario. For example, a large-scale graph pattern matching and query capability provided by the graph query method can be fully applied to data mining and analysis in scenarios such as a large social network and a shopping network, thereby greatly improving computing efficiency.

A specific implementation process is as follows.

The user 102 submits a sub-graph query statement to the front end 104. The sub-graph query statement is understood as a graph pattern (that is, a sub-graph) expressed by using a target graph description language (for example, a graph description language such as Cypher, GraphSQL, or Gremlin), for example, a match ( ) statement using the language Gremlin: query a graph pattern matching merchant-product-user. After receiving the sub-graph query statement, the front end 104 converts the match ( ) statement using the language Gremlin into PatternDesc (that is, a graph pattern structure, which may also be referred to as a sub-graph structure). The PatternDesc is used for expressing a graph pattern, and is independent of a language. Any graph pattern expressed by using the graph description language is converted into the PatternDesc.

After receiving the PatternDesc, the front end 104 generates, based on a pre-defined computing complexity estimation model and with reference to sub-graph statistical information stored in a pre-constructed graph data structure, a graph pattern query policy with a low computing complexity, converts the graph pattern query policy into DataflowDesc (a data flow structure) that can be executed by the back end 106, and sends the data flow structure to the back end 106.

After receiving the data flow structure, the back end 106 parses the data flow structure based on a node in a distributed cluster, to generate corresponding execution code, and finally performs processing of graph pattern matching and query, to obtain a graph pattern corresponding to the query statement. In addition, the graph pattern corresponding to the query statement is returned to the front end 104, and the front end 104 displays the graph pattern to the user 102.

The graph query method provided in the embodiments of the present disclosure provides complete support in a graph description language, and abstracts the PatternDesc, which is a data level that is independent of the language, so that the graph query system retains a capability of accessing more languages in the future (to be specific, in an actual project scenario, the complete support in the graph description language is very important, the graph description language enables a development staff to intuitively and clearly describe a graph pattern that needs to be queried for by the development staff; and the support of the graph query method in the graph description language not only improves development efficiency, but also facilitates later maintenance of the graph query system). In addition, the graph data structure (such as the GLogue) is provided to store high-dimensional statistical information (that is, the sub-graph statistical information) in the graph, to optimize the graph pattern matching and query method, so that a more efficient graph pattern query policy with low computing complexity can be generated to perform subsequent graph pattern matching and query, thereby further improving a query speed of the graph pattern matching and query. In addition, the back end also performs graph pattern matching and query by using a parallel capability of the distributed cluster and by fully using hardware resources, thereby greatly improving execution efficiency of the graph pattern matching and query.

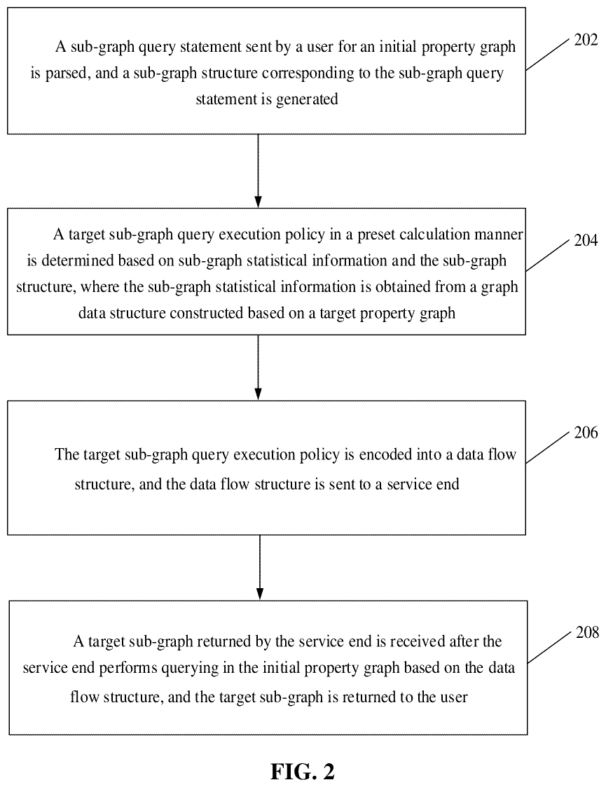

FIG. 2 is a flowchart of a graph query method applied to a client according to some embodiments of the present disclosure. Specifically, the method includes the following steps.

In step 202, a sub-graph query statement sent by a user for an initial property graph is parsed, and a sub-graph structure corresponding to the sub-graph query statement is generated.

The client is understood as the front end 102 in the some embodiments. For explanations of the user and the sub-graph query statement, also refer to detailed descriptions of the some embodiments. For example, the user is understood as a development staff that is to subsequently perform data mining or data analysis by using a matched and queried graph pattern, and the sub-graph query statement is understood as a graph pattern query statement edited based on any graph description language (for example, a graph description language such as Cypher, GraphSQL, or Gremlin). The sub-graph structure is understood as the PatternDesc in the some embodiments, to be specific, a data structure that is used to express a graph pattern, that is independent of the graph description language, and that can be processed by the client.

In addition, the sub-graph query statement sent by the user for the initial property graph is understood as a sub-graph query statement sent by the user for an initial property graph of a target item. The target item is understood as an e-commerce item, a social item, or the like. The initial property graph of the target item is understood as a set of vertexes and edges, where objects in the target item serve as the vertexes, and associations between the objects serve as the edges. For example, when the target item is the e-commerce item, the objects in the e-commerce item is understood as a merchant, a user, a product, and the like, and the associations between the objects are understood as that a user purchases a product of a merchant.

In at least one embodiment of the present disclosure, the client includes a graph pattern parsing node, a policy optimization node, and a management node. Therefore, when the client includes the three nodes, an operation of parsing the sub-graph query statement sent by the user for the initial property graph, and generating the sub-graph structure corresponding to the sub-graph query statement is understood as follows. The graph pattern parsing node receives the sub-graph query statement sent by the user for the initial property graph, pares the sub-graph query statement, and generates the sub-graph structure corresponding to the sub-graph query statement. For example, the graph pattern parsing node receives a match statement that is edited by using the language Gremlin and that is sent by the user for an initial property graph of an e-commerce item, parses the match statement sent by the user, and generates PatternDesc corresponding to the match statement.

However, when the graph pattern parsing node parses the sub-graph query statement sent by the user for the initial property graph, and generates the sub-graph structure corresponding to the sub-graph query statement, to avoid a problem that some invalid sub-graph query statements are received, resulting in invalid computation subsequently performed at a service end, and a waste of resources, in a process of parsing the received sub-graph query statement sent by the user, the graph pattern parsing node evaluates validity of the sub-graph query statement. A specific implementation is as follows.

An operation of parsing a sub-graph query statement sent by a user for an initial property graph, and generate a sub-graph structure corresponding to the sub-graph query statement includes the following steps.

The sub-graph query statement sent by the user is received, and the sub-graph query statement is parsed.

When a parsing result satisfies a preset query condition, generating the sub-graph structure corresponding to the sub-graph query statement; or when the parsing result does not satisfy the preset query condition, returning a preset query result to the user.

The preset query condition is set based on an actual application. For example, the preset query condition is understood as that the sub-graph query statement is valid.

In at least one embodiment of the present disclosure, connections in the initial property graph of the target item that are reasonable and connections in the initial property graph of the target item that are unreasonable is pre-defined. That is, forms of connections existing in the initial property graph of the target item are pre-determined, and these reasonable forms of connections are pre-stored in the client in a manner of a table or in another manner. For example, a merchant can establish a connection to a store, but cannot establish a connection to a product. In this case, after the sub-graph query statement sent by the user for the initial property graph of the target item is parsed, when it is discovered that the user forcibly connects the merchant to the product in the sub-graph query statement, it is determined, based on the pre-stored reasonable forms of connections, that the sub-graph query statement is unreasonable and is an invalid query statement.

In this case, when the preset query condition is understood as that the sub-graph query statement is valid, an operation of receiving the sub-graph query statement sent by the user, and parsing the sub-graph query statement; and when the parsing result satisfies the preset query condition, generating the sub-graph structure corresponding to the sub-graph query statement is understood as follows. The graph pattern parsing node receives the sub-graph query statement sent by the user, parses the sub-graph query statement, and when determining, based on the parsing result, that the sub-graph query statement is valid, converts the sub-graph query statement into the sub-graph structure, that is, generates the sub-graph structure corresponding to the sub-graph query statement.

An operation of, when the parsing result does not satisfy the preset query condition, returning the preset query result to the user is understood as follows. When determining, based on the parsing result, that the sub-graph query statement does not satisfy the validity of the sub-graph query statement, that is, the sub-graph query statement is invalid, the graph pattern parsing node directly returns the preset query result to the user, for example, returns an empty set.

According to the graph query method provided in the embodiments of the present disclosure, after receiving the sub-graph query statement sent by the user, in a process of converting the sub-graph query statement into the corresponding sub-graph structure, the graph pattern parsing node of the client may discover some invalid query statements in advance, and filter out the invalid query statements, to avoid invalid computation subsequently performed in the distributed cluster of the service end, and greatly improve resource utilization of the graph pattern matching and query.

In step 204, a target sub-graph query execution policy in a preset calculation manner is determined based on sub-graph statistical information and the sub-graph structure, where the sub-graph statistical information is obtained from a graph data structure constructed based on a target property graph.

Specifically, after determining that the sub-graph query statement is valid, and converting the sub-graph query statement into the corresponding sub-graph structure, the graph pattern parsing node of the client sends the sub-graph structure to the policy optimization node of the client. After receiving the sub-graph structure, the policy optimization node obtains the sub-graph statistical information from the graph data structure constructed based on the target property graph, and then determines the target sub-graph query execution policy in the preset calculation manner based on the sub-graph statistical information and the sub-graph structure. The sub-graph statistical information is understood as high-dimensional statistical information of the target property graph (for example, a property graph of the target item, that is, an initial property graph, or a property graph obtained after the initial property graph is sampled). The high-dimensional statistical information is relative to low-dimensional statistical information. The low-dimensional statistical information in the target property graph is understood as statistics on a quantity of various vertexes and edges. It is assumed that there are three vertexes, namely, a user, a store, and a product, and three edges, namely, user-follow→store, user-purchase→product, and store-provide→product, in a target property graph. Low-dimensional statistical information of the target property graph is represented by the following Table 1:

| Vertex/edge | Quantity |
|---|---|
| User | * |
| Store | * |
| Product | * |
| User-follow→store | * |
| User-purchase→product | * |
| Store-provide→product | * |

High-dimensional statistical information of the target property graph is understood as statistics on quantities of various graph patterns based on the target property graph, as shown in the following Table 2:

| Graph pattern | Quantity |
|---|---|
| . . . | * |
| User-follow→store- | * |
| provide→product | |
| User-purchase→product<- | * |
| provide-store | |
| . . . | * |

That is, it can be learned according to Table 2 that the sub-graph statistical information is understood as statistical information of all graph patterns for the target property graph.

The preset calculation manner is set based on an actual application, for example, a shortest path algorithm.

Before the target sub-graph query execution policy is determined in the preset calculation manner based on the sub-graph statistical information and the sub-graph structure, the graph data structure further needs to be constructed in advance, so that the sub-graph statistical information of the target property graph can be subsequently obtained from the graph data mechanism. A specific implementation is as follows.

Before determining the target sub-graph query execution policy in the preset calculation manner based on the sub-graph statistical information and the sub-graph structure, the graph query method further includes the following steps.

The target property graph sent by the service end is received, and the sub-graph statistical information in the target property graph is determined.

The graph data structure in a form of the target property graph is constructed based on the sub-graph statistical information, and the sub-graph statistical information is stored in the graph data structure.

The target property graph is understood as an initial property graph of the target item in the some embodiments, or is understood as a property graph obtained after the initial property graph is sampled, and is specifically determined based on specific sending of the service end.

Specifically, the management node of the client receives the target property graph sent by the service end, extracts the sub-graph statistical information in the target property graph, constructs the graph data structure in the form of the target property graph based on the sub-graph statistical information, and stores the sub-graph statistical information in the graph data structure.

The graph data structure is understood as the foregoing GLogue. The extracted high-dimensional statistical information is stored in the form of the target property graph. In the property graph in which the high-dimensional statistical information is stored, each point represents a graph pattern, and a statistical quantity thereof is stored as a property of the point. An edge represents a conversion relationship between graph patterns. For example, one edge connects two points, and the two points respectively represent two graph patterns, namely, “user-follow→store” and “user-follow→store-provide→product”. In this case, the edge represents that the graph pattern “user-follow→store” is converted into the graph pattern “user-follow→store-provide→product” by adding “-provide→product” to the graph pattern “user-follow→store”.

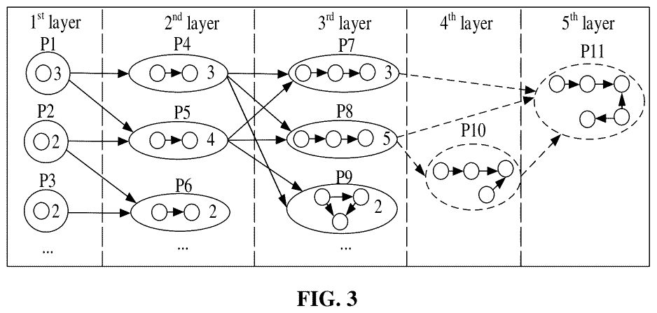

FIG. 3 is a schematic diagram of a graph data structure in a graph query method according to some embodiments of the present disclosure.

FIG. 3 shows a graph data structure constructed based on the extracted high-dimensional statistical information stored in the form of the target property graph. Each point in FIG. 3 represents one graph pattern. For example, P1 to P11 each represent one graph pattern. Some properties, such as a quantity of graph patterns, are stored on each point, and the quantity is stored in the graph as a property (for example, a quantity 3 of graph patterns in P1, a quantity 2 of graph patterns in P2, or a quantity 2 of graph patterns in P3).

According to the graph query method provided in the embodiments of the present disclosure, the graph data structure is provided to store the high-dimensional statistical information of the target property graph, and the management node of the graph data structure is introduced to create, subsequently manage, and maintain the graph data structure, so that the high-dimensional statistical information can be efficiently extracted from the graph data structure subsequently, to generate a more optimal execution policy, and the execution policy can be applied to a large-scale graph scenario. In addition, the sub-graph statistical information is stored in the graph data structure in the form of the target property graph, so that the sub-graph statistical information can reuse graph storage of the service end for reliable storage and migration. That is, the graph data structure stores the sub-graph statistical information in the form of the target property graph, so that the sub-graph statistical information can reuse an existing graph storage node of the service end, thereby saving storage resources.

After the graph data structure is constructed, during actual application, the sub-graph statistical information of the target property graph is obtained from the graph data structure, then statistics is performed on the graph model statistical information based on a pre-defined computing complexity estimation model, and the target sub-graph query execution policy is determined by using a preset computing method with reference to the sub-graph structure. A specific implementation is as follows.

An operation of determining the target sub-graph query execution policy in the preset calculation manner based on the sub-graph statistical information and the sub-graph structure includes the following steps.

A target point corresponding to the sub-graph structure is determined in the graph data structure based on the sub-graph structure.

Sub-graph statistical information associated with the target point is determined, and the target sub-graph query execution policy is determined by using a shortest path algorithm.

Specifically, after receiving the sub-graph structure, the policy optimization node performs positioning in the graph data structure by using the sub-graph structure. That is, the policy optimization node finds a target point corresponding to the sub-graph structure in the graph data structure. After the target point corresponding to the sub-graph structure is positioned in the graph data structure, the target sub-graph query execution policy corresponding to the sub-graph structure is generated by using the shortest path algorithm in the graph.

In at least one embodiment of the present disclosure, since a size of the GLogue is limited, the GLogue may not include quantity statistical information of all possible graph patterns.

Therefore, when the GLogue is initially initialized (constructed), only a quantity of graph patterns whose sizes are less than or equal to k and a quantity of some other graph patterns that are usually queried for are recorded. For example, during construction of the GLogue, a management node r (GLogue Manage) of the graph data structure first calculates a quantity of small graph patterns and a quantity of some patterns that occur at a high frequency, and stores, in the GLogue in a form of a property graph, the quantities of the patterns and associations between the patterns. In this case, there is inevitably a case in which the sub-graph structure queried for by the user has no related high-dimensional statistical information stored in the GLogue. The policy optimization node (Plan Optimizer) heuristically generates an execution policy of a sub-graph query statement (Pattern Match), and records a graph pattern that is not included in the GLogue. Then, some patterns for which the user submits queries and that are not included in the GLogue are gradually updated into the GLogue.

According to the graph query method provided in the embodiments of the present disclosure, a problem of searching for a preferred execution policy of graph pattern matching is converted into a classic shortest path problem in the graph field (that is, a point of a queried graph pattern is positioned in a property graph of the high-dimensional statistical information stored in the GLogue, and a shortest path from the point to a point at a first layer is searched for). Through this method, the more efficient target sub-graph query execution policy can be generated, thereby further improving a query speed of graph pattern matching. In addition, a threshold and heart load of a development staff for using graph pattern query are greatly reduced, which facilitates pushing popularization of the graph pattern query in an actual item scenario.

In step 206, the target sub-graph query execution policy is encoded into a data flow structure, and the data flow structure is sent to a service end.

Specifically, after determining the target sub-graph query execution policy, the policy optimization node of the client encodes the target sub-graph query execution policy into the data flow structure that can be processed by the service end, and sends the data flow structure to the service end.

In step 208, a target sub-graph returned by the service end is received after the service end performs querying in the initial property graph based on the data flow structure, and the target sub-graph is returned to the user.

Specifically, after sending the data flow structure to the service end, the policy optimization node of the client may further receive the target sub-graph returned by the service end based on the data flow structure, and return the target sub-graph to the graph pattern parsing node of the client. The graph pattern parsing node returns the target sub-graph to the user.

To be specific, after receiving the PatternDesc, the Plan Optimizer performs statistics on the high-dimensional statistical information in the graph data structure based on the pre-defined computing complexity estimation model, and then generates, based on a statistics result by using the shortest path algorithm, an execution policy (that is, the target sub-graph query execution policy) having a computing complexity as low as possible. That is, the execution policy having the computing complexity as low as possible is converted into a shortest path problem in the graph field based on a statistics estimation model. For example, a computer queries for a link merchant-product-user, and there are three possible policies, where two ends are used as vertexes, or an intermediate point is used as a vertex, and extension is performed toward two sides. For example, in a shopping network, a quantity of users is large, a quantity of stores is less than the quantity of users, and a quantity of merchants is less than the quantity of stores. When extension starts from the user, many additional queries are triggered. In this case, it can be determined, by using the computing complexity estimation model, that computing complexity of starting from the merchant to the store and then to the user is lowest. However, when the graph pattern is large, there are many points, so that the execution policies will then be very numerous. The execution policies are converted into problems of searching for a shortest path in the pattern, so that the problems can be simply and intuitively resolved, to find an execution policy with lowest computing complexity. For example, all merchants are first obtained. A second intermediate process is from the merchant to the store. A third intermediate process from the store to the user. Results of the first two processes are used as an intermediate process thereof. A quantity of graph patterns in the first two intermediate processes needs to be first counted by using a method, quantity estimation in the intermediate process is determined, and a conversion distance in each step is determined by using the quantity estimation in the intermediate process. A more optimal execution policy is found based on a shortest path algorithm in the graph. In addition, the execution policy is converted into the data flow structure (DataflowDesc). The DataflowDesc includes a series of common operators in a flow processing engine, such as Map, FlatMap, and Filter, to send the data flow structure including the target operator to the flow processing engine in the service end for calculation. In addition, an execution result returned by the flow processing engine in the service end is returned to the user.

A specific implementation is as follows.

An operation of encoding the target sub-graph query execution policy into a data flow structure, and sending the data flow structure to a service end includes the following steps.

An operation of encoding the target sub-graph query execution policy into a data flow structure, and sending the data flow structure to a service end includes the following steps.

The target sub-graph query execution policy is encoded into a data flow structure including a target operator, and the data flow structure is sent to a data flow processing engine of the service end, where the target operator is an operator associated with the data flow processing engine.

Correspondingly, an operation of receiving the target sub-graph returned by the service end after the service end performs querying in the initial property graph based on the data flow structure includes the following steps.

The target sub-graph queried for and returned by the data flow processing engine of the service end based on the data flow structure in the initial property graph is received.

Specifically, the policy optimization node of the client encodes the target sub-graph query execution policy into the data flow structure including the target operator, and sends the data flow structure to the data flow processing engine of the service end; and receives the target sub-graph returned after the data flow processing engine of the service end processes the data flow structure.

According to the graph query method provided in the embodiments of the present disclosure, the target sub-graph query execution policy is encoded into the data flow structure including the target operator, so that the data flow processing engine of the service end can subsequently identify the data flow structure quickly, and accurately execute the data flow structure based on the target operator in the data flow structure, to obtain the target sub-graph.

In addition, in at least one embodiment of the present disclosure, when the management node of the client discovers that some graph patterns are often queried for by the user but are never stored in the graph data structure, an update mechanism is triggered, to update the graph patterns and high-dimensional statistical information of the graph patterns into a graph data structure. Therefore, when the user subsequently queries for one of the graph patterns again, a more optimal execution policy for matching and query of the graph pattern can be obtained more efficiently and accurately, thereby improving graph pattern matching and query efficiency. A specific implementation is as follows.

After parsing the sub-graph query statement sent by the user for the initial property graph, and generate the sub-graph structure corresponding to the sub-graph query statement, the graph query method further includes the following steps.

A query count for a query sub-graph corresponding to the sub-graph structure is determined.

When the query count for the query sub-graph is greater than or equal to a query count threshold, and no sub-graph statistical information in the graph data structure corresponds to the query sub-graph, a statistical information update request is sent to the service end.

An updated property graph returned by the service end based on the statistical information update request is received, and the sub-graph statistical information stored in the graph data structure is updated based on the updated property graph.

The query sub-graph is understood as a graph pattern corresponding to the sub-graph structure. Specifically, when the graph pattern parsing node of the client converts the sub-graph query statement into the corresponding sub-graph structure, and sends the sub-graph structure to the policy optimization node of the client, the graph pattern parsing node sends the sub-graph structure to the management node. The management node determines, based on a historical record, the query count for the query sub-graph corresponding to the sub-graph structure. For example, when the query sub-graph corresponding to the sub-graph structure has been historically queried for 10 times, the current query count for is the 11th time. When the query count for the query sub-graph is greater than or equal to the query count threshold (for example, eight or nine times), and no sub-graph statistical information in the graph data structure corresponds to the query sub-graph, the statistical information update request is sent to the service end, to request to update the graph data structure. In addition, when the updated property graph returned by the service end based on the statistical information update request is received, the sub-graph statistical information stored in the graph data structure is updated based on the updated property graph.

According to the graph query method provided in the embodiments of the present disclosure, when the management node of the client determines that graph pattern query frequently submitted by the user is not inputted into the graph data structure, to improve matching and query efficiency of the graph pattern, the management node triggers the update mechanism to the service end, to update these graph patterns and high-dimensional statistical information thereof into the graph data structure.

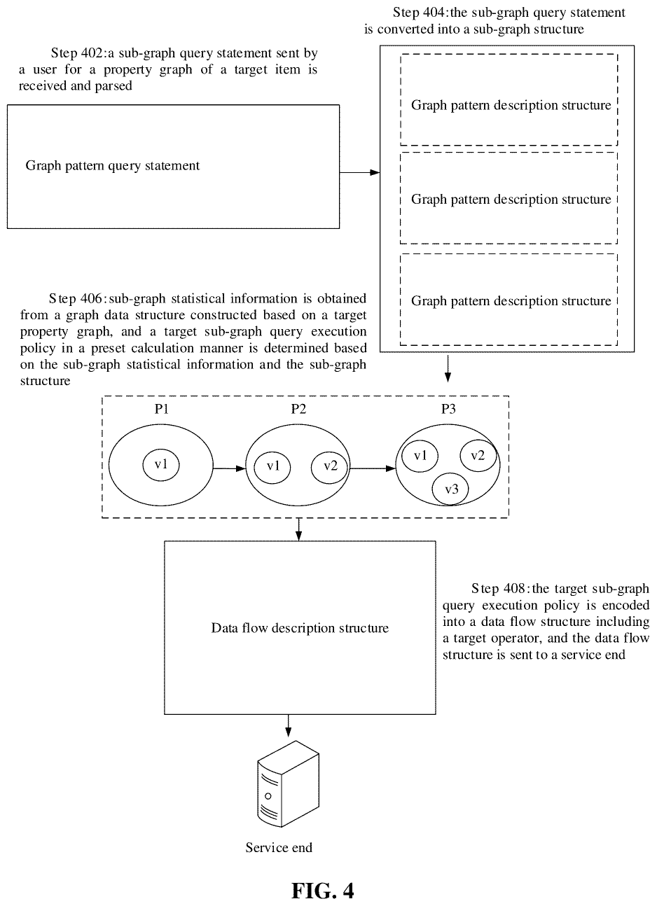

FIG. 4 is a flowchart of a specific processing process of a graph query method according to some embodiments of the present disclosure.

In step 402, a sub-graph query statement sent by a user for a property graph of a target item is received and parsed.

For example, the sub-graph query statement is: P=g·V( )·match (

```
  as(‘v1’).out(‘Knows’).as(‘v2’),
  as(‘v1’).out(‘Purchases’).as(‘v3’),
  as(‘v2’).out(‘Purchases’).as(‘v3’)
)
```

In step 404, the sub-graph query statement is converted into a sub-graph structure.

The foregoing example continues to be used. A sub-graph structure obtained after as (‘v1’).out (‘Knows’).as (‘v2’) is converted is:

```
[GetV(NA,‘v1’,Person,NA),
  GetE(‘v1’,‘ ’,Knows,Out),
  GetV(‘ ’,‘v2’,Person,Target),
]
```

A sub-graph structure obtained after as (‘v1’).out (‘Purchases’).as (‘v3’) is converted is:

[GetV(NA,‘v1’,Person,NA),
GetE(‘v1’,‘ ’,Purchases,Out),
GetV(‘ ’,‘v3’,Product,Target),
]

A sub-graph structure obtained after as (‘v2’).out (‘Purchases’).as (‘v3’) is converted is:

[GetV(NA,‘v2’,Person,NA),
GetE(‘v2’,‘ ’,Purchases,Out),
GetV(‘ ’,‘v2’,Product,Target),
]

In step 406, sub-graph statistical information is obtained from a graph data structure constructed based on a target property graph, and a target sub-graph query execution policy in a preset calculation manner is determined based on the sub-graph statistical information and the sub-graph structure.

In step 408, the target sub-graph query execution policy is encoded into a data flow structure including a target operator, and the data flow structure is sent to a service end.

The foregoing example continues to be used. The data flow structure including the target operator is as follows:

Source(GetV(NA,‘v1’,Person,NA))
FlatMap(GetE(‘v1’,‘ ’,Knows,Out))
Map(GetV(‘ ’,‘v2’,Person,Target))
Map(GetE(‘v1’,‘_t’,Purchases,Out))
Map(GetE(‘v2’,‘_t’,Purchases,Out))
FlatMap(GetE(‘v3’,‘_t’,Product,Other))
FlatMap(GetE(‘v3’,‘_t’,Product,Other))

After the data flow structure is sent to the service end, the target sub-graph returned by the service end based on the data flow structure is received, and the target sub-graph is returned to the user.

The graph query method provided in the embodiments of the present disclosure is applied to the client, and provides an approach for matching and querying for the graph pattern based on the sub-graph statistical information. In full consideration of an association between the sub-graph statistical information stored in the graph data structure and information, the target sub-graph query execution policy that is better in time and space complexity is generated in combination with the preset calculation manner, and the target sub-graph query execution policy is encoded into the data flow structure that can be executed by the service end, so that subsequently the service end can efficiently analyze an association between data based on the data flow structure, and simply and quickly match and query for the graph pattern.

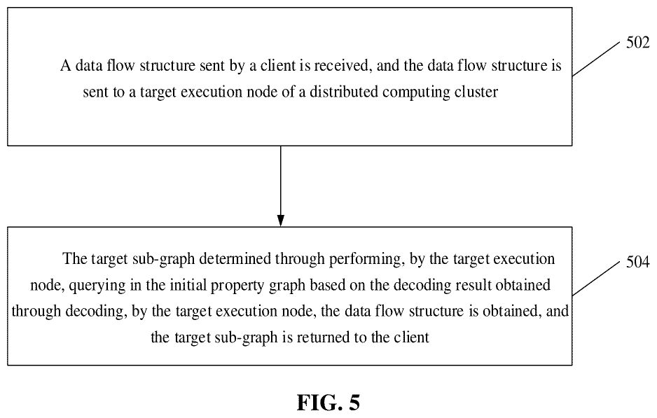

FIG. 5 is a flowchart of a graph query method applied to a service end according to some embodiments of the present disclosure. Specifically, the method includes the following steps.

In step 502, a data flow structure sent by a client is received, and the data flow structure is sent to a target execution node of a distributed computing cluster.

The service end is understood as the back end 106 in the some embodiments. The data flow structure is understood as the data flow structure determined in the graph query method applied to the client.

Specifically, the service end includes a distributed flow engine processing node and a distributed graph storage node. In some implementable embodiments, the service end may further include a graph sparse node that supports being deployed in a large-scale distributed computing cluster. The distributed flow engine processing node includes a group of executors, and each of the executors is correspondingly allocated to an execution node of the distributed computing cluster. The executors on the execution nodes support efficient data exchange between each other, to deal with a case in which a queried graph pattern may cross nodes.

Based on the distributed computing cluster, an operation that the service end receives the data flow structure sent by the client, and sends the data flow structure to the target execution node of the distributed computing cluster is understood as follows. The service end receives the data flow structure sent by the client, and then sends, in a form of an RPC service, the data flow structure to the target execution node (for example, each execution node or a specified execution node) of the distributed computing cluster.

In step 504, the target sub-graph determined through performing, by the target execution node, querying in the initial property graph based on the decoding result obtained through decoding, by the target execution node, the data flow structure is obtained, and the target sub-graph is returned to the client.

For introduction of the initial property graph, refer to the detailed introduction of the graph query method applied to the client. Specifically, after each target execution node receives the data flow structure, an executor allocated to each target execution node decodes the data flow structure, extracts an operator (such as Map or FlatMap) in the data flow structure, then generates corresponding execution code, and finally performs graph pattern matching and query based on the initial property graph, to obtain the target sub-graph, and returns the target sub-graph to the client.

The initial property graph is understood as an initial property graph of a target item, for example, an initial property graph of an e-commerce website, or an initial property graph of a social networking website. For specific explanations of the target item and the property graph, refer to the some embodiments. Details are not described herein again.

In at least one embodiment of the present disclosure, before the data flow structure sent by the client is received, the initial property graph further needs to be determined and stored in advance, so that matching and querying of the graph pattern can be subsequently performed based on the initial property graph. In addition, based on the distributed computing cluster, when storage of the initial property graph occupies large space, the initial property graph is split into several small graphs for distributed storage, thereby greatly improving storage efficiency and efficiency of subsequent graph pattern matching and query. A specific implementation is as follows.

Before receiving data flow structure sent by the client, the graph query method further includes the following steps.

The initial property graph is determined, the initial property graph is split according to a preset splitting policy, and split initial property graphs are respectively stored in the target execution node of the distributed computing cluster.

During specific implementation, after the initial property graph is determined, when it is determined that space occupied by storage of the initial property graph is greater than or equal to preset storage space (where the preset storage space is set based on an actual application, for example, the preset storage space is 100 TB or 80 TB), or when the space occupied by the storage is greater than or equal to the preset storage space as the initial property graph is updated, it is difficult for a standalone mode to satisfy storage and computing requirements of the initial property graph. Therefore, in the embodiments of the present disclosure, the large initial property graph is split into multiple small graph partitions according to a Hash partition policy or another partition policy. The small graph partitions are respectively stored on each execution node of the distributed computing cluster, and are uniformly managed by the distributed graph storage node of the service end.

To be specific, the distributed graph storage node of the service end determines the initial property graph. When it is determined that the space occupied by the storage of the initial property graph is greater than or equal to the preset storage space, the initial property graph is split according to the preset splitting policy (for example, the Hash partition policy), and the split initial property graphs are respectively stored in the target execution node of the distributed computing cluster. Therefore, when an executor in the target execution node performs target sub-graph matching and query based on the data flow structure, the executor may load, by using the distributed graph storage node, the small graph partitions stored in each target execution node into an internal memory, to form the initial property graph, so as to complete the target sub-graph matching and query in cooperation with the data flow structure, thereby obtaining the target sub-graph.

During specific implementation, at an initialization stage, the service end needs to send the initial property graph to the client, so that the client can construct the graph data structure based on high-dimensional statistical information in the initial property graph. After the initial property graph is large or is updated for many times and a size of the graph increases to a particular scale, to establish an available graph data structure within a reasonable time range, the management node of the graph data structure does not directly extract the high-dimensional statistical information from the initial property graph stored in the service end to establish the graph data structure. A reason lies in that, it is discovered in research that generation of a more optimal execution policy does not require completely accurate high-dimensional statistical information, and statistical information within a reasonable deviation range is sufficient to help the Plan Optimizer to generate a preferred execution policy. Based on this, the embodiments of the present disclosure provides a “new graph sampling algorithm”, and the graph sparse node (Graph Sparsifier) is designed for specific execution. A function of the graph sparse node is to sample the initial property graph (that is, a large graph) as a small graph. The small graph is greatly simplified in volume, but retains basic structure information of the large graph.

Through this sampling algorithm, a smaller estimation error can be achieved at the same sampling rate, to further improve establishment efficiency of the GLogue. Therefore, during system initialization, the Graph Sparsifier of the service end simultaneously starts, samples the entire large graph as the small graph, summarizes the sampled small graph, and sends the sampled small graph to the GLogue Manager of the client. Then, the GLogue Manager performs statistics on high-dimensional information in the small graph, and performs scaling by using a pre-defined stratified function (stratified function) to obtain data in the large graph. A specific implementation is as follows.

After respectively storing, in the target execution node of the distributed computing cluster, the split initial property graphs, the graph query method further includes the following steps.

The split initial property graphs is determined from the target execution node of the distributed computing cluster in response to a system initialization request.

Sampling is performed on the split initial property graphs according to a preset sampling policy, to obtain a target property graph, and the target property graph is sent to the client, where the target property graph is smaller than a split initial property graph.

When the client and the service end are considered as a graph query system, the system initialization request is understood as an initialization request of the graph query system.

Specifically, the graph sparse node of the service end triggers, in response to the system initialization request, the distributed graph storage node to determine the initial property graph from the target execution node of the distributed computing cluster. The distributed graph storage node sends the initial property graph to the graph sparse node. After receiving the initial property graph, the graph sparse node samples the initial property graph according to the preset sampling policy, to obtain the target property graph, and sends the target property graph to the management node of the client, so that the management node of the client constructs the graph data structure based on the target property graph.

In addition, in at least one embodiment of the present disclosure, since the initial property graph is split and stored in different execution nodes of the distributed computing cluster, when target sub-graph query is performed in the initial property graph based on the data flow structure, the different execution nodes of the distributed computing cluster rapidly find corresponding graph patterns in the initial property graph from the nodes of the different execution nodes, and then all the graph patterns found by the execution nodes need to be summarized, to obtain the target sub-graph. A specific implementation is as follows.

An operation of decoding the data flow structure based on the target execution node, obtaining the target sub-graph determined through performing, by the target execution node, querying in the initial property graph based on the decoding result includes the following steps.

The data flow structure is decoded based on the target execution node, and the target sub-graph determined through performing, by the target execution node, based on the decoding result, querying in a split initial property graph corresponding to the decoding result is obtained.

Specifically, the distributed flow engine processing node of the service end decodes the data flow structure based on the executor of the target execution node allocated to the distributed computing cluster, obtains the target sub-graph determined by the executor of each target execution node by performing, based on the decoding result, querying in the split initial property graph corresponding to the decoding result, and summarizes each initial graph pattern, to determine the target sub-graph. Through the distributed query, efficiency of matching and query of a graph pattern is greatly improved.

The graph query method provided in the embodiments of the present disclosure that is applied to the service end provides a distributed execution engine and distributed storage that are efficient and completed. Therefore, when the service end performs graph pattern matching and query, computing resources in the cluster can be fully used, thereby greatly improving a query speed of the graph pattern matching. In addition, Worst-Case-Optimal Join is supported at an execution engine layer, thereby ensuring an upper limit of computing complexity of the execution policy, and greatly improving a query success rate under same hardware resources.

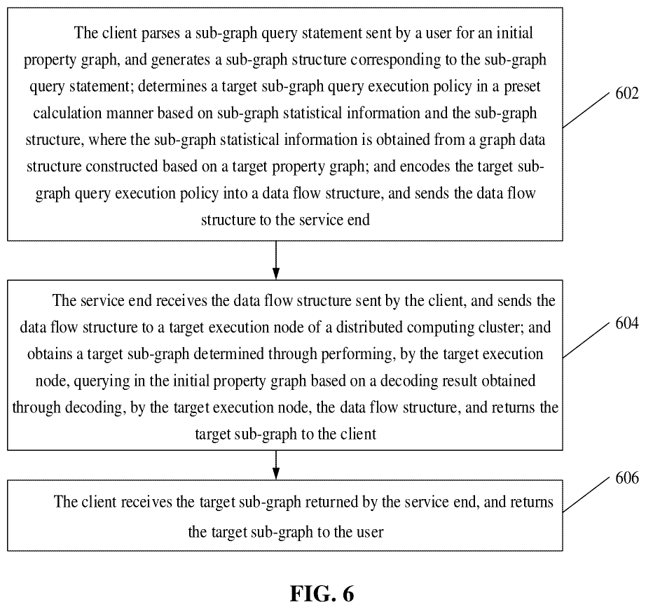

FIG. 6 is a flowchart of a graph query method applied to a graph query system according to some embodiments of the present disclosure. The graph query system includes a client and a service end. The method specifically includes the following steps.

In step 602, the client parses a sub-graph query statement sent by a user for an initial property graph, and generates a sub-graph structure corresponding to the sub-graph query statement; determines a target sub-graph query execution policy in a preset calculation manner based on sub-graph statistical information and the sub-graph structure, where the sub-graph statistical information is obtained from a graph data structure constructed based on a target property graph; and encodes the target sub-graph query execution policy into a data flow structure, and sends the data flow structure to the service end.

In step 604, the service end receives the data flow structure sent by the client, and sends the data flow structure to a target execution node of a distributed computing cluster; and obtains a target sub-graph determined through performing, by the target execution node, querying in the initial property graph based on a decoding result obtained through decoding, by the target execution node, the data flow structure, and returns the target sub-graph to the client.

In step 606, the client receives the target sub-graph returned by the service end, and returns the target sub-graph to the user.

Optionally, the client includes a graph pattern parsing node and a policy optimization node.

Correspondingly, the graph pattern parsing node parses the sub-graph query statement sent by the user for the initial property graph, generates the sub-graph structure corresponding to the sub-graph query statement, and sends the sub-graph structure to the policy optimization node.

The policy optimization node determines the target sub-graph query execution policy in the preset calculation manner based on the sub-graph statistical information and the sub-graph structure. The sub-graph statistical information is obtained from the graph data structure constructed based on the target property graph.

The policy optimization node encodes the target sub-graph query execution policy into the data flow structure, and sends the data flow structure to the service end.

Optionally, the client further includes a management node.

Correspondingly, the management node receives the target property graph sent by the service end, and determines the sub-graph statistical information in the target property graph; and the management node constructs the graph data structure in a form of the target property graph based on the sub-graph statistical information, and stores the sub-graph statistical information in the graph data structure.

Optionally, the service end includes a distributed flow engine processing node and a distributed graph storage node.

Correspondingly, the distributed flow engine processing node receives the data flow structure sent by the client 602, and sends the data flow structure to the target execution node of the distributed computing cluster, where the data flow structure is obtained through processing, by the client, the received sub-graph query statement; and the distributed flow engine processing node obtains the target sub-graph determined through performing, by the target execution node, querying in the initial property graph based on the decoding result obtained through decoding, by the target execution node, the data flow structure, and returns the target sub-graph to the client.

Optionally, the service end further includes a graph sparse node.

The graph sparse node determines, based on the distributed storage node, the initial property graph from the target execution node of the distributed computing cluster in response to a system initialization request; and the graph sparse node performs sampling on the initial property graph according to a preset sampling policy, to obtain a target property graph, and sends the target property graph to the client, where the target property graph is smaller than the initial property graph.

Specifically, the graph query system is understood as the graph pattern matching and query system, namely, the GLogS, in the some embodiments.

For specific explanations of the client, the service end, the graph pattern parsing node, the policy optimization node, and the management node that are included in the client, and the distributed flow engine processing node, the distributed graph storage node, and the graph sparse node that are included in the service end, refer to specific explanations of the graph query method applied to the client and the graph query method applied to the service end.

Details are not described herein again.

The graph query method provided in the embodiments of the present disclosure is applied to the graph query system GLogS that can deal with large-scale graph pattern query. The GLogS completely includes a front-end module and a back-end module, and comprehensively interconnects, in an end-to-end manner, all links in a process from inputting a query statement on a user side to finally returning a result by an execution engine, so that a high-frequency requirement of graph pattern matching and query is highly available in an actual item scenario. In addition, the GLogS proposes an innovative data structure, namely, the GLogue, to store the high-dimensional statistical information in the graph, and introduces the GLogue Manager to create, manage, and maintain the GLogue. In addition, through cooperation and interworking between multiple modules, such as the GLogue, the GLogue Manager, and the Graph Sparsifier, not only efficiency of extracting the high-dimensional statistical information from the graph is greatly improved, so that the graph query method can be applied to a large-scale graph scenario, but also the statistical information extracted from the graph can reuse graph storage in the system for reliable storage and migration. In addition, the distributed execution engine and the distributed storage that are efficient are also provided, thereby greatly improving efficiency of graph pattern matching and query.

Specifically, the graph query method applied to the graph query system completely provides a solution of extracting the high-dimensional statistical information from the large-scale graph, and resolves problems such as difficult storage, slow computation, and high internal memory consumption caused when the high-dimensional statistical information is extracted from the large-scale graph. In addition, a Stratified Sparsification algorithm is provided, so that high-dimensional information such as a quantity of graph patterns is well retained in a process of sampling a large graph as a small graph. When information statistics efficiency is greatly improved, high accuracy is also retained. An innovative native data structure of a graph, namely, the GLogue, is also provided to store the high-dimensional statistical information in the graph, and the GLogue Manager is introduced to create, manage, and maintain the GLogue. The high-dimensional statistical information is stored by using the graph, so that not only the information can be stored, but also associations between the information can be stored. The associations not only can help generation of an execution policy, so that the generated execution policy is as optimal as possible in terms of time or space complexity, but also can greatly improve efficiency of extracting the high-dimensional statistical information from the graph. Based on mutual correlation between the high-dimensional information in the GLogue, an algorithm for efficiently extracting the high-dimensional statistical information from the graph is provided, thereby greatly improving construction efficiency of the GLogue. In addition, based on a structure of a GLogue property graph, an execution policy generation problem of graph pattern matching is further converted into a classical shortest path problem in the graph field, and the problem is resolved by using a Viterbi algorithm. Therefore, not only generation efficiency of the execution policy is improved, but also a generation process of the execution policy is easier, clearer, and more intuitive. In addition, in the method, a flow processing engine based on a directed acyclic graph (DAG) is used for allocating a task of graph pattern query to a large-scale cluster for processing. After an execution policy is generated based on the GLogue, the Plan Optimizer in the GLogS translates each step in the execution policy into a corresponding operator in the flow processing engine, encodes the execution policy into a DataflowDesc structure, and sends the DataflowDesc structure to an executor of each execution node in each cluster for computation in a manner of a RPC (Remote Procedure Call, remote procedure call) service. This design enables the GLogS to have good scalability in a computation process.

The foregoing is an example solution of the graph query method applied to the graph query system in the embodiments. It should be noted that the technical solution of the graph query method applied to the graph query system belongs to the same concept as the foregoing technical solutions of the graph query method applied to the client and the graph query method applied to the service end. For details that are not described in detail in the technical solution of the graph query method applied to the graph query system, refer to the descriptions of the foregoing technical solutions of the graph query method applied to the client and the graph query method applied to the service end.

Corresponding to the foregoing method embodiments, the present disclosure further provides some embodiments of a graph query apparatus applied to a client. FIG. 7 is a structural schematic diagram of a graph query apparatus applied to a client according to some embodiments of the present disclosure.

As shown in FIG. 7, the apparatus includes:
a graph pattern parsing node 702, configured to parse a sub-graph query statement sent by a user for an initial property graph, and generate a sub-graph structure corresponding to the sub-graph query statement; and
a policy optimization node 704, configured to determine a target sub-graph query execution policy in a preset calculation manner based on sub-graph statistical information and the sub-graph structure, where the sub-graph statistical information is obtained from a graph data structure constructed based on a target property graph.

The policy optimization node 704 is further configured to encode the target sub-graph query execution policy into a data flow structure, and send the data flow structure to a service end.

The graph pattern parsing node 702 is further configured to receive a target sub-graph returned by the service end after the service end performs querying in the initial property graph based on the data flow structure, and return the target sub-graph to the user.

Optionally, the apparatus further includes a management node, configured to:
receive the target property graph sent by the service end, and determine the sub-graph statistical information in the target property graph; and
construct the graph data structure in a form of the target property graph based on the sub-graph statistical information, and store the sub-graph statistical information in the graph data structure.

Optionally, the graph pattern parsing node 702 is further configured to:
receive the sub-graph query statement sent by the user, and parse the sub-graph query statement; and
when a parsing result satisfies a preset query condition, generate the sub-graph structure corresponding to the sub-graph query statement; or
when the parsing result does not satisfy the preset query condition, return a preset query result to the user.

Optionally, the policy optimization node 704 is further configured to:
determine, in the graph data structure based on the sub-graph structure, a target point corresponding to the sub-graph structure; and
determine the sub-graph statistical information associated with the target point, and determine the target sub-graph query execution policy by using a shortest path algorithm.

Optionally, the policy optimization node 704 is further configured to:
encode the target sub-graph query execution policy into a data flow structure including a target operator, and send the data flow structure to a data flow processing engine of the service end, where the target operator is an operator associated with the data flow processing engine.

Correspondingly, the policy optimization node 704 is further configured to:
receive the target sub-graph queried for and returned by the data flow processing engine of the service end based on the data flow structure in the initial property graph.

Optionally, the management node is further configured to:
determine a query count for a query sub-graph corresponding to the sub-graph structure;
when the query count for the query sub-graph is greater than or equal to a query count threshold, and no sub-graph statistical information in the graph data structure corresponds to the query sub-graph, send a statistical information update request to the service end; and
receive an updated property graph returned by the service end based on the statistical information update request, and update, based on the updated property graph, the sub-graph statistical information stored in the graph data structure.

The foregoing is an example solution of the graph query apparatus used in the client in the embodiments. It should be noted that the technical solution of the graph query apparatus used in the client belongs to the same concept as the foregoing technical solution of the graph query method applied to the client. For details that are not described in detail in the technical solution of the graph query apparatus used in the client, refer to the descriptions of the foregoing technical solution of the graph query method applied to the client.

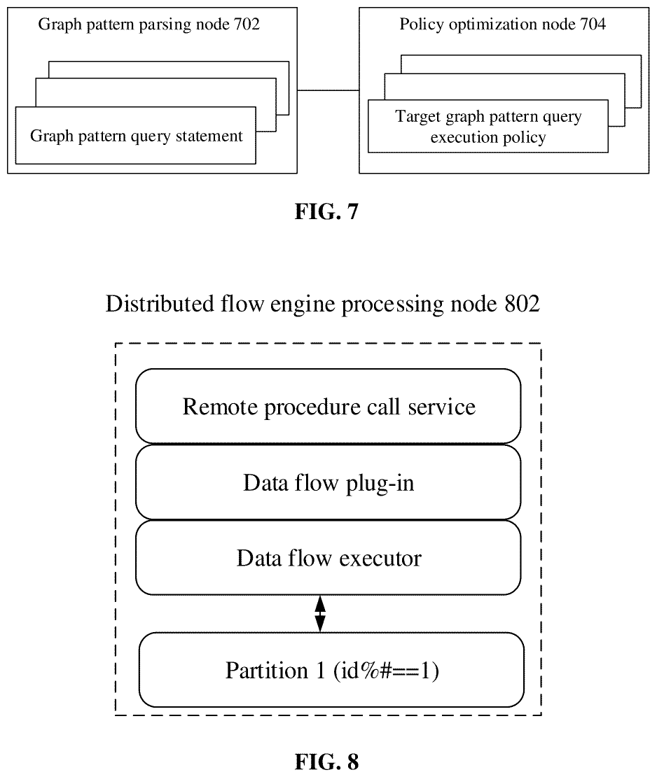

Corresponding to the foregoing method embodiments, the present disclosure further provides some embodiments of a graph query apparatus applied to a service end. FIG. 8 is a structural schematic diagram of a graph query apparatus applied to a service end according to some embodiments of the present disclosure.

As shown in FIG. 8, the apparatus includes:

a distributed flow engine processing node 802, configured to receive a data flow structure sent by a client, and send the data flow structure to a target execution node of a distributed computing cluster, where the data flow structure is obtained through processing, by the client, a received sub-graph query statement.

The distributed flow engine processing node is further configured to obtain the target sub-graph determined through performing, by the target execution node, querying in the initial property graph based on the decoding result obtained through decoding, by the target execution node, the data flow structure, and return the target sub-graph to the client.

In some embodiments, the apparatus further includes:
a distributed graph storage node, configured to:
determine the initial property graph, split the initial property graph according to a preset splitting policy, and respectively store, in the target execution node of the distributed computing cluster, split initial property graphs.

In some embodiments, the apparatus further includes:
a graph sparse node, configured to:
determine the split initial property graphs from the target execution node of the distributed computing cluster in response to a system initialization request; and
perform sampling on the split initial property graphs according to a preset sampling policy, to obtain the target property graph, and send the target property graph to the client, where the target property graph is smaller than a split initial property graph.

The distributed flow engine processing node 804 is further configured to:
decode the data flow structure based on the target execution node, and obtain the target sub-graph determined through performing, by the target execution node, based on the decoding result, querying in a split initial property graph corresponding to the decoding result.

The foregoing is an example solution of the graph query apparatus used in the service end in the embodiments. It should be noted that the technical solution of the graph query apparatus used in the service end belongs to the same concept as the foregoing technical solution of the graph query method applied to the service end. For details that are not described in detail in the technical solution of the graph query apparatus used in the service end, refer to the descriptions of the foregoing technical solution of the graph query method applied to the service end.

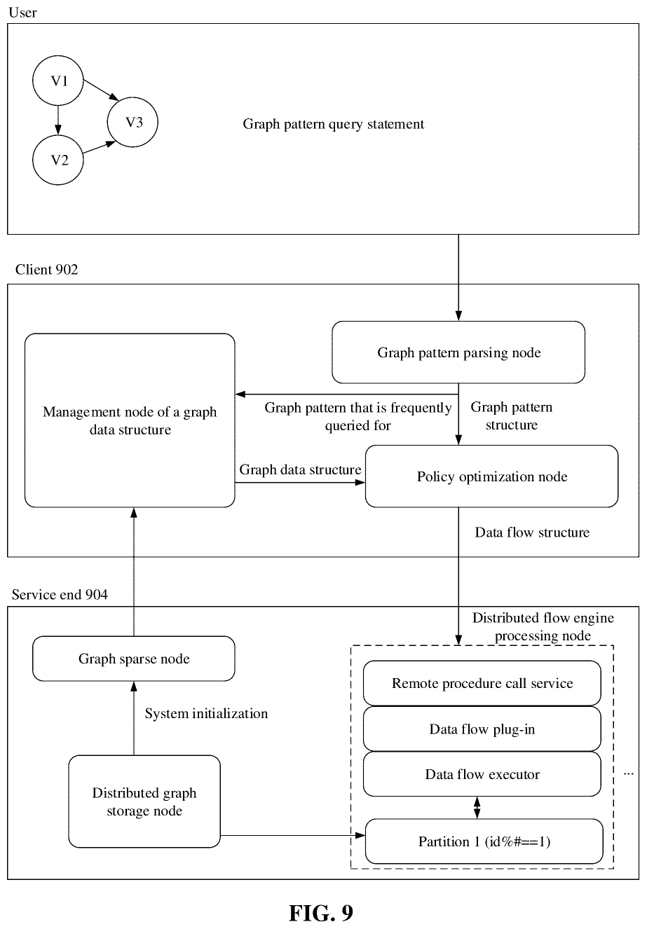

Corresponding to the foregoing method embodiments, the present disclosure further provides some embodiments of a graph query system. FIG. 9 is a structural schematic diagram of a graph query system according to some embodiments of the present disclosure. As shown in FIG. 9, the system includes:
a client 902, configured to parse a sub-graph query statement sent by a user for an initial property graph, and generate a sub-graph structure corresponding to the sub-graph query statement; determine a target sub-graph query execution policy in a preset calculation manner based on sub-graph statistical information and the sub-graph structure, where the sub-graph statistical information is obtained from a graph data structure constructed based on a target property graph; and encode the target sub-graph query execution policy into a data flow structure, and send the data flow structure to a service end 904; and
the service end 904, configured to receive the data flow structure sent by the client 902, and send the data flow structure to a target execution node of a distributed computing cluster; and obtain a target sub-graph determined through performing, by the target execution node, querying in the initial property graph based on a decoding result obtained through decoding, by the target execution node, the data flow structure, and return the target sub-graph to the client 902.

The client 902 is further configured to receive the target sub-graph returned by the service end 904, and return the target sub-graph to the user.

Optionally, the client 902 includes a graph pattern parsing node and a policy optimization node.

Correspondingly, the graph pattern parsing node is configured to parse the sub-graph query statement sent by the user for the initial property graph, generate the sub-graph structure corresponding to the sub-graph query statement, and send the sub-graph structure to the policy optimization node.

The policy optimization node is configured to determine a target sub-graph query execution policy in a preset calculation manner based on sub-graph statistical information and the sub-graph structure, where the sub-graph statistical information is obtained from a graph data structure constructed based on a target property graph.

The policy optimization node is further configured to encode the target sub-graph query execution policy into a data flow structure, and send the data flow structure to a service end 904.

Optionally, the client 902 further includes a management node.

Correspondingly, the management node is configured to receive the target property graph sent by the service end 904, and determines the sub-graph statistical information in the target property graph; and
construct the graph data structure in a form of the target property graph based on the sub-graph statistical information, and store the sub-graph statistical information in the graph data structure.

Optionally, the service end 904 includes a distributed flow engine processing node and a distributed graph storage node.

Correspondingly, the distributed flow engine processing node is configured to receive the data flow structure sent by the client 902, and send the data flow structure to the target execution node of the distributed computing cluster, where the data flow structure is obtained through processing, by the client, the received sub-graph query statement; and
obtain the target sub-graph determined through performing, by the target execution node, querying in the initial property graph based on the decoding result obtained through decoding, by the target execution node, the data flow structure, and return the target sub-graph to the client 902.

Optionally, the service end 904 further includes a graph sparse node.

The graph sparse node is configured to determine, based on the distributed storage node, the initial property graph from the target execution node of the distributed computing cluster in response to a system initialization request; and perform sampling on the initial property graph according to a preset sampling policy, to obtain a target property graph, and send the target property graph to the client 902, where the target property graph is smaller than the initial property graph.

With reference to FIG. 9, a processing process of graph pattern query is specifically described by using an example in which the graph query system is a GLogS system.

As to system startup and initialization, when a system is started up, an initial property graph is loaded into the system, the initial property graph is split into multiple small graph partitions according to a Hash partitioning policy, the small graph partitions are respectively stored in nodes of a distributed computing cluster, and are uniformly managed by a distributed graph storage node (Graph Store). When the system is initialized, an executor allocated to a distributed flow engine processing node (Distributed DataFlow Engine) of each node loads a small graph partition stored in a corresponding node into an internal memory. Then, a graph sparse node reads the initial property graph based on the Graph Store, performs sparse sampling, to generate a sparse small graph, and provides the small graph to a management node (GLogue Manager) of a graph data structure. After receiving the small graph, the GLogue Manager extracts high-dimensional statistical information from the small graph and deduces the high-dimensional statistical information, establishes the graph data structure (GLogue), and stores the high-dimensional statistical information in the GLogue in a form of a property graph. After being generated, the GLogue is provided to a policy optimization node (Plan Optimizer) to optimize a query committed by a user in the future. Simultaneously, a graph pattern parsing node (Pattern Paser), a PlanOptimizer, a remote procedure call service (RPC Service), a data flow plug-in (Dataflow Plugin), and a data flow executor (Dataflow Executor) are also started up together to prepare for processing upcoming graph pattern query. Since then, system startup and initialization phases end.

A specific graph pattern query process is as follows.

Step 1, a user enters a statement Gremlin match, that is, a graph pattern query statement, into a front end of the GLogS system.

Step 2, after receiving the statement Gremlin match, the front end (that is, the client 902) Pattern Parser converts the statement Gremlin match into a PatternDesc structure, that is, a graph pattern structure, and sends the PatternDesc structure to the Plan Optimizer.

Step 3, the front end Plan Optimizer generates, based on a computing complexity estimation model defined in advance, the PatternDesc structure, and the high-dimensional statistical information stored in the GLogue, an execution policy with lowest computing complexity.

Step 4, the front end PlanOptimizer converts the execution policy into a data flow structure (DataflowDesc) including a target flow operator, and sends the DataflowDesc to the back end (that is, the service end 904) Distributed DataFlow Engine.

Step 5, the back end Distributed DataFlow Engine sends, in a form of the remote procedure call service (that is, the RPC service), the DataflowDesc to an executor allocated to each node in the distributed computing cluster, and the executor of each node decodes the DataflowDesc, extracts the flow operator in the DataflowDesc, and generates corresponding execution code.

Step 6, each executor executes the code matching the graph pattern query statement, generate a corresponding graph pattern query result, and return the graph pattern query result to the Distributed DataFlow Engine for summarization. The DistributedDataFlowEngine finally returns the summarized graph pattern query result to the user by using the front end Pattern Paser. In addition, the management node of the graph data structure further processes a case in which a graph pattern is frequently queried for but no high-dimensional statistical information corresponds to the graph pattern in the graph data structure. For a specific processing manner, refer to the some embodiments, and details are not described herein again.

The foregoing is an example solution of the graph query system in the embodiments. It should be noted that the technical solution of the graph query system belongs to the same concept as the foregoing technical solution of the graph query method applied to the graph query system. For details that are not described in detail in the technical solution of the graph query system, refer to the descriptions of the foregoing technical solution of the graph query method applied to the graph query system.

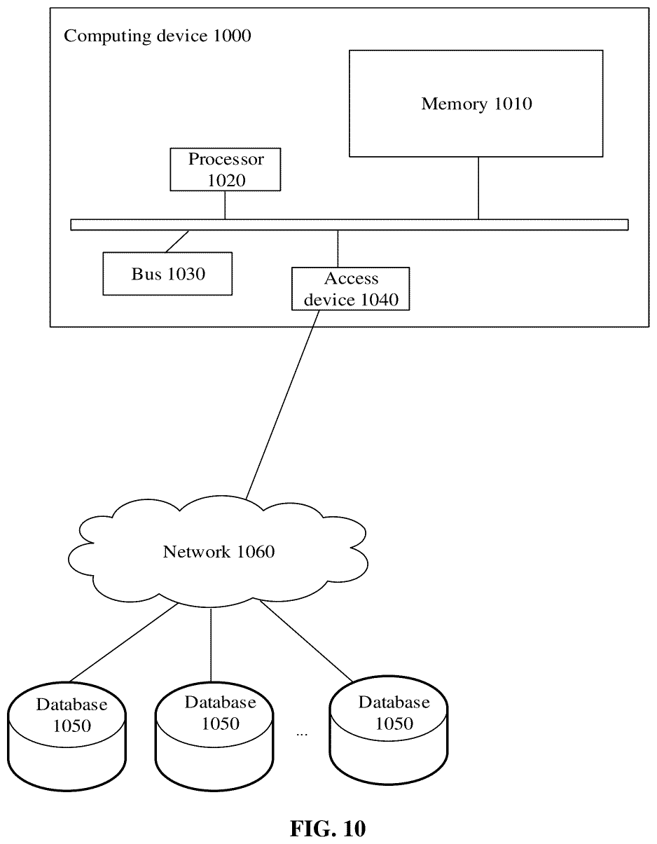

FIG. 10 is a structural block diagram of a computing device 1000 according to some embodiments of the present disclosure. Components of the computing device 1000 include, but are not limited to, a memory 1010 and a processor 1020. The processor 1020 is connected with the memory 1010 by using a bus 1030, and a database 1050 is configured to store data.

The computing device 1000 further includes an access device 1040, and the access device 1040 enables the computing device 1000 to communicate via at least one network 1060. Examples of these networks include a public switched telephone network (PSTN), a local area network (LAN), a wide area network (WAN), a personal area network (PAN), or a combination of communication networks such as the Internet. The access device 1040 may include at least one of any type of wired or wireless network interface (for example, a network interface controller (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In some embodiments of the present disclosure, the foregoing components of the computing device 1000 and other components not shown in FIG. 10 may also be connected with each other, for example, by using the bus. It should be understood that the block diagram of the structure of the computing device shown in FIG. 10 is taken as an example, but is not intended to limit the scope of the present disclosure. A person having ordinary skill in the art may add or replace other components as required.

The computing device 1000 is any type of static or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses), another type of mobile device, or a static computing device such as a desktop computer or a personal computer (PC). The computing device 1000 may alternatively be a mobile or static server.

The processor 1020 is configured to execute the following computer-executable instructions. When the computer-executable instructions are executed by the processor, steps of the foregoing graph query method are implemented. The foregoing is an example solution of the computing device in the embodiments. It should be noted that the technical solution of the computing device belongs to the same concept as the foregoing technical solution of the graph query method. For details that are not described in detail in the technical solution of the computing device, refer to the descriptions of the foregoing technical solution of the graph query method.

Some embodiments of the present disclosure further provides a computer-readable storage medium, storing computer-executable instructions. When the computer-executable instructions are executed by a processor, steps of the foregoing graph query method are implemented.

The foregoing is an example solution of the computer-readable storage medium in the embodiments. It should be noted that the technical solution of the storage medium belongs to the same concept as the foregoing technical solution of the graph query method. For details that are not described in detail in the technical solution of the storage medium, refer to the descriptions of the foregoing technical solution of the graph query method.

Some embodiments of the present disclosure further provides a computer program. When the computer program is executed in a computer, the computer is enabled to perform steps of the foregoing graph query method.

The foregoing is an example solution of the computer program in the embodiments. It should be noted that the technical solution of the computer program belongs to the same concept as the foregoing technical solution of the graph query method. For details that are not described in detail in the technical solution of the computer program, refer to the descriptions of the foregoing technical solution of the graph query method.

The specific embodiments of the present disclosure are described above. Other embodiments fall within the scope of the appended claims. In some embodiments, the actions or steps recorded in the claims are performed in sequences different from those in the embodiments and an expected result may still be achieved. In addition, the processes depicted in the accompanying drawings is not necessarily performed in the specific order or successively to achieve an expected result. In some implementations, multitasking and parallel processing is feasible or beneficial.

The computer instructions include computer program code, and the computer program code is in a form of source code, a form of object code, a form of an executable file, some intermediate forms, or the like. The computer-readable medium may include any entity or apparatus that can carry the computer program code, a record medium, a USB flash drive, a removable hard disk, a magnetic disk, an optical disc, a computer memory, a read-only memory (ROM), a random access memory (RAM), an electric carrier signal, a telecommunication signal, a software distribution medium, and the like. It should be noted that content included in the computer-readable medium is properly increased or decreased according to requirements of legislation and patent practices in jurisdictions. For example, in some jurisdictions, according to legislation and patent practices, the computer-readable medium does not include the electric carrier signal and the telecommunication signal.

It needs to be noted that, for ease of description, the method embodiments are described as a series of action combinations. However, a person having ordinary skill in the art should know that the embodiments of the present disclosure are not limited to the described order of actions, since some steps are performed in another order or simultaneously according to the embodiments of the present disclosure. In addition, a person having ordinary skill in the art should also learn that, the embodiments described in this specification are all preferred embodiments, and actions and modules involved are not necessarily all required in the embodiments of the present disclosure.

In the some embodiments, the descriptions of the embodiments have their respective focuses. For a part that is not described in detail in some embodiments, reference is made to related descriptions in other embodiments.

The exemplary embodiments of the present disclosure disclosed above are used for helping explain the present disclosure. The optional embodiments do not describe all details in detail, and do not limit the present invention to specific implementations. It is clear that many modifications and variations can be made according to the content of the embodiments of the present disclosure. In the present disclosure, these embodiments are selected and specifically described to better explain the principle and the practical application of the embodiments of the present disclosure, so that a person having ordinary skill in the art can understand and use the present disclosure well. The present disclosure is subject to the claims and all ranges and equivalents thereof.

### INDUSTRIAL APPLICABILITY

The graph query method provided in the embodiments of the present disclosure is applied to the client, and provides a method for matching and querying for a graph pattern based on the sub-graph statistical information. In full consideration of an association between the sub-graph statistical information stored in the graph data structure and information, the target sub-graph query execution policy that is better in time and space complexity is generated in combination with the preset calculation manner, and the target sub-graph query execution policy is encoded into the data flow structure that can be executed by the service end, so that subsequently the service end can efficiently analyze an association between data based on the data flow structure, and simply and quickly match and query for the graph pattern.

1. A graph query method, applied to a client, and comprising:
parsing a sub-graph query statement sent by a user for an initial property graph, and generating a sub-graph structure corresponding to the sub-graph query statement;
determining a target sub-graph query execution policy in a preset calculation manner based on sub-graph statistical information and the sub-graph structure, wherein the sub-graph statistical information is obtained from a graph data structure constructed based on a target property graph;
encoding the target sub-graph query execution policy into a data flow structure, and sending the data flow structure to a service end; and
receiving a target sub-graph returned by the service end after the service end performs querying in the initial property graph based on the data flow structure, and returning the target sub-graph to the user.

2. The graph query method according to claim 1, wherein before determining the target sub-graph query execution policy in the preset calculation manner based on the sub-graph statistical information and the sub-graph structure, the graph query method further comprises:
receiving the target property graph sent by the service end, and determining the sub-graph statistical information in the target property graph; and
constructing the graph data structure in a form of the target property graph based on the sub-graph statistical information, and storing the sub-graph statistical information in the graph data structure.

3. The graph query method according to claim 1, wherein parsing the sub-graph query statement sent by the user for the initial property graph, and generating the sub-graph structure corresponding to the sub-graph query statement comprises:
receiving the sub-graph query statement sent by the user, and parsing the sub-graph query statement; and
when a parsing result satisfies a preset query condition, generating the sub-graph structure corresponding to the sub-graph query statement; or
when the parsing result does not satisfy the preset query condition, returning a preset query result to the user.

4. The graph query method according to claim 1, wherein determining the target sub-graph query execution policy in the preset calculation manner based on the sub-graph statistical information and the sub-graph structure comprises:
determining, in the graph data structure based on the sub-graph structure, a target point corresponding to the sub-graph structure; and
determining the sub-graph statistical information associated with the target point, and determining the target sub-graph query execution policy by using a shortest path algorithm.

5. The graph query method according to claim 1, wherein after parsing the sub-graph query statement sent by the user for the initial property graph, and generating the sub-graph structure corresponding to the sub-graph query statement, the graph query method further comprises:
determining a query count for a query sub-graph corresponding to the sub-graph structure;
when the query count for the query sub-graph is greater than or equal to a query count threshold, and no sub-graph statistical information in the graph data structure corresponds to the query sub-graph, sending a statistical information update request to the service end; and
receiving an updated property graph returned by the service end based on the statistical information update request, and updating, based on the updated property graph, the sub-graph statistical information stored in the graph data structure.

6. A graph query method, applied to a service end, and comprising:
receiving a data flow structure sent by a client, and sending the data flow structure to a target execution node of a distributed computing cluster, wherein the data flow structure is obtained through processing, by the client, a received sub-graph query statement; and
obtaining the target sub-graph determined through performing, by the target execution node, querying in the initial property graph based on the decoding result obtained through decoding, by the target execution node, the data flow structure, and returning the target sub-graph to the client.

7. The graph query method according to claim 6, wherein before receiving the data flow structure sent by the client, the graph query method further comprises:
determining the initial property graph, splitting the initial property graph according to a preset splitting policy, and respectively storing, in the target execution node of the distributed computing cluster, split initial property graphs.

8. The graph query method according to claim 7, wherein after the respectively storing, in the target execution node of the distributed computing cluster, the split initial property graphs, the graph query method further comprises:
determining the split initial property graphs from the target execution node of the distributed computing cluster in response to a system initialization request; and
performing sampling on the split initial property graphs according to a preset sampling policy, to obtain the target property graph, and sending the target property graph to the client, wherein the target property graph is smaller than a split initial property graph.

9. The graph query method according to claim 7, wherein decoding the data flow structure based on the target execution node, obtaining the target sub-graph determined through performing, by the target execution node, querying in the initial property graph based on the decoding result comprises:
decoding the data flow structure based on the target execution node, and obtaining the target sub-graph determined through performing, by the target execution node, querying in a split initial property graph corresponding to the decoding result.

10. A graph query method, applied to a graph query system, wherein the graph query system comprises a client and a service end, and the method comprises:
the client parsing a sub-graph query statement sent by a user for an initial property graph, and generating a sub-graph structure corresponding to the sub-graph query statement; determining a target sub-graph query execution policy in a preset calculation manner based on sub-graph statistical information and the sub-graph structure, wherein the sub-graph statistical information is obtained from a graph data structure constructed based on a target property graph; and encoding the target sub-graph query execution policy into a data flow structure, and sending the data flow structure to the service end;
the service end receiving the data flow structure sent by the client, and sending the data flow structure to a target execution node of a distributed computing cluster; and obtaining a target sub-graph determined through performing, by the target execution node, querying in the initial property graph based on a decoding result obtained through decoding, by the target execution node, the data flow structure, and returning the target sub-graph to the client; and
the client receiving the target sub-graph returned by the service end, and returning the target sub-graph to the user.

11. The graph query method according to claim 10, wherein the client comprises a graph pattern parsing node and a policy optimization node; and
correspondingly, the client parsing the sub-graph query statement sent by the user for the initial property graph, and generating the sub-graph structure corresponding to the sub-graph query statement; determining the target sub-graph query execution policy in the preset calculation manner based on sub-graph statistical information and the sub-graph structure, wherein the sub-graph statistical information is obtained from the graph data structure constructed based on the target property graph; and encoding the target sub-graph query execution policy into the data flow structure, and sending the data flow structure to the service end comprises:
the graph pattern parsing node parsing the sub-graph query statement sent by the user for the initial property graph, generating the sub-graph structure corresponding to the sub-graph query statement, and sending the sub-graph structure to the policy optimization node;
the policy optimization node determining the target sub-graph query execution policy in the preset calculation manner based on the sub-graph statistical information and the sub-graph structure, wherein the sub-graph statistical information is obtained from the graph data structure constructed based on the target property graph; and
the policy optimization node encoding the target sub-graph query execution policy into the data flow structure, and sending the data flow structure to the service end.

12. The graph query method according to claim 11, wherein the client further comprises a management node; and
correspondingly, before the policy optimization node determining the target sub-graph query execution policy in the preset calculation manner based on the sub-graph statistical information and the sub-graph structure, the method further comprises:
the management node receiving the target property graph sent by the service end, and determining the sub-graph statistical information in the target property graph; and
the management node constructing the graph data structure in a form of the target property graph based on the sub-graph statistical information, and storing the sub-graph statistical information in the graph data structure.

13. The graph query method according to claim 10, wherein the service end comprises a distributed flow engine processing node and a distributed graph storage node; and
correspondingly, the service end receiving the data flow structure sent by the client, and sending the data flow structure to the target execution node of the distributed computing cluster; and obtaining the target sub-graph determined through performing, by the target execution node, querying in the initial property graph based on the decoding result obtained through decoding, by the target execution node, the data flow structure, and returning the target sub-graph to the client comprises:
the distributed flow engine processing node receiving the data flow structure sent by the client, and sending the data flow structure to the target execution node of the distributed computing cluster, wherein the data flow structure is obtained through processing, by the client, the received sub-graph query statement; and
the distributed flow engine processing node obtaining the target sub-graph determined through performing, by the target execution node, querying in the initial property graph based on the decoding result obtained through decoding, by the target execution node, the data flow structure, and returning the target sub-graph to the client.

14. The graph query method according to claim 13, wherein the service end further comprises a graph sparse node; and the method further comprises:
the graph sparse node determining, based on the distributed storage node, the initial property graph from the target execution node of the distributed computing cluster in response to a system initialization request; and
the graph sparse node performing sampling on the initial property graph according to a preset sampling policy, to obtain the target property graph, and sending the target property graph to the client, wherein the target property graph is smaller than the initial property graph.

15. The graph query method according to claim 1, wherein parsing the sub-graph query statement sent by the user for the initial property graph comprises:
parsing the sub-graph query statement sent by the user for the initial property graph of a target item, wherein the initial property graph of the target item is a set of vertexes and edges, where objects in the target item serve as the vertexes, and associations between the objects serve as the edges.

16. The graph query method according to claim 3, wherein when the parsing result satisfies the preset query condition, generating the sub-graph structure corresponding to the sub-graph query statement comprises:
when determining, based on the parsing result, that the sub-graph query statement is valid, converting the sub-graph query statement into the sub-graph structure.

17. The graph query method according to claim 3, wherein when the parsing result does not satisfy the preset query condition, returning the preset query result to the user comprises:
when determining, based on the parsing result, that the sub-graph query statement is invalid, returning the preset query result to the user, wherein the preset query result comprises an empty set.

18. The graph query method according to claim 1, wherein encoding the target sub-graph query execution policy into the data flow structure, and sending the data flow structure to the service end comprises:
encoding the target sub-graph query execution policy into a data flow structure comprising a target operator, and sending the data flow structure to a data flow processing engine of the service end, wherein the target operator is an operator associated with the data flow processing engine.

19. The graph query method according to claim 18, wherein receiving the target sub-graph returned by the service end after the service end performs querying in the initial property graph based on the data flow structure comprises:
receiving the target sub-graph returned by the data flow processing engine of the service end after the data flow processing engine performs querying in the initial property graph based on the data flow structure.

20. The graph query method according to claim 5, wherein the query sub-graph is a graph pattern corresponding to the sub-graph structure.
